(19) United States
(12) Patent Application Publication
(10) Pub. No.: US 2017/0137445 A1
(43) Pub. Date: May 18, 2017

(54) METHOD FOR PRODUCING POWDERS FROM ALKALI SALTS OF SILANOLS

(71) Applicant: Wacker Chemie AG, Munich (DE)

(72) Inventors: Michael STEPP, Ueberackern (AT); Sabine HOFFMANN, Radebeul (DE); Marcel KORNELI, Dresden (DE); Daniel SCHILDBACH, Altoetting (DE)

(73) Assignee: Wacker Chemie AG, Munich (DE)

(21) Appl. No.: 15/127,538

(22) PCT Filed: Mar. 13, 2015
(86) PCT No.: PCT/EP2015/055325

§ 371 Date: Sep. 20, 2016

(30) Foreign Application Priority Data
Mar. 20, 2014 (DE) 10 2014 205 258.0

(51) Int. Cl. C07F 7/08; C04B 24/42

(52) U.S. Cl. CPC C07F 7/0836; C04B 24/42; C04B 2103/30

(57) ABSTRACT

Alkali metal siliconates with low contents of water and alcohol are economically prepared in a three stage process where organoalkoxysilanes are reacted with a basic alkali metal salt to form an alcohol-rich hydrolysate, the hydrolysate is dried to a powder containing 0.5-5 wt. % alcohol, and residual alcohol is reduced in a post-treatment third step.

### CROSS REFERENCE TO RELATED APPLICATIONS

This application is the U.S. National Phase of PCT Appln. No. PCT/EP2015/055325 filed Mar. 13, 2015, which claims priority to German Application No. 10 2014 205 258.0 filed Mar. 20, 2014, the disclosures of which are incorporated in their entirety by reference herein.

### BACKGROUND OF THE INVENTION

1. Field of the Invention

The invention relates to a process for producing powder (P) of silanol salts (hereinafter also referred to as siliconates) from alkoxysilanes, a basic alkali metal salt and water, powder (P), building material mixtures and also components or shaped bodies.

2. Description of the Related Art

Alkali metal organosiliconates such as potassium methylsiliconate have been used for decades for hydrophobicization, in particular of mineral building materials. Owing to their good solubility in water, they can be applied as an aqueous solution to solids where, after evaporation of the water, they form firmly adhering, durably water-repellent surfaces under the influence of carbon dioxide. Since they contain virtually no organic radicals which can be split off hydrolytically, curing advantageously occurs without liberation of undesirable volatile, organic by-products.

The preparation of alkali metal organosiliconates, in particular potassium and sodium methylsiliconates, has been described many times. In most cases, the focus is on the production of ready-to-use and storage-stable, aqueous solutions. For example, DE 4336600 describes a continuous process proceeding from organotrichlorosilanes via the intermediate organotrialkoxysilane. An advantage here is that the by-products hydrogen chloride and alcohol formed can be recovered and the siliconate solution formed is virtually chlorine-free.

Ready-to-use building material mixtures such as cement or gypsum plasters and renders and knifing fillers or tile adhesives are supplied mainly as powder in sacks or silos to the building site and only there are mixed with the make-up water. A solid hydrophobicizing agent which can be added to the ready-to-use dry mixture and displays its hydrophobicizing effect in a short time only on addition of water during application in-situ, e.g. on the building site, is required for this purpose. This is referred to as dry mix use. Organosiliconates in solid form have been found to be very efficient hydrophobicizing additives for this purpose. The preparation and use of these has been described, for example, in the following documents:

The patent application WO 12022544 claims solid organosiliconates having a reduced alkali content. They are prepared by hydrolysis of alkoxysilanes or halosilanes by means of aqueous alkali metal hydroxide and azeotropic drying of the resulting optionally alcoholic-aqueous siliconate solution with the aid of an inert solvent as azeotropic entrainer. WO 12159874 describes, inter alia, solid organosiliconates which are prepared from mixtures of hydrolysable methylsilanes and alkylsilanes (>C₄) and aqueous bases. Drying of these also preferably occurs azeotropically.

Various drying methods for these salts have been described, and these aim to circumvent the viscous phase states as drying progresses, for example by drying in a powder bed (WO 13075969). A disadvantage of this process is the long residence time in the dryer, which in the case of thermally sensitive siliconate salts can lead to composition phenomena which can bring about reduced effectiveness in the use. An alternative is two-stage drying in which a large part of the alcohol is firstly distilled off and the remaining viscous residue is then evaporated to dryness under reduced pressure (WO 13041385). Here too, the long residence time in the dryer is disadvantageous. It results from the high process engineering complexity since the second drying step proceeds under reduced pressure. This fact also makes it difficult for the process to be carried out continuously since it is necessary to effect transport of the sticky, highly viscous partially dried medium from the first drying step into a second vacuum-tight process apparatus.

In all these processes, the siliconates are generally isolated by drying the reaction mixtures derived from one or more alkoxysilane(s) and a basic salt. The reaction mixtures are usually solutions or dispersions, e.g. suspensions or emulsions, which contain the siliconate together with water and at least the alcohol liberated in the reaction. For economic reasons, the amount of water added is generally only the amount required for very complete hydrolysis of the alkoxy or halogen radicals since an excess of water has to be removed again during drying, which consumes energy and costs money. This leads to a high proportion of alcohol being present in the final reaction mixture (frequently a two-figure percentage range) in alkoxysilane hydrolyses. Owing to the hydrolysis equilibrium, the alcohol is both chemically bound to silicon (Si-alkoxy) and also physically to the solid in these mixtures. In contrast to the absorptively bound alcohol, the chemically bound alcohol cannot be removed completely from the solid during the drying process and a residual alkoxy content remains, depending on the alcohol content of the aqueous-alcoholic reaction mixture, in the siliconate powder. The presence of moisture during storage or addition of water during use results in hydrolysis of these alkoxy groups, with the alcohol being liberated. Owing to the toxicity and ignition risk of the alcohols (predominantly methanol or ethanol), this is undesirable and is a great disadvantage for use as hydrophobicizing agent for building materials since storage and handling of additives and building materials to which additives have been added in the presence of air are a basic prerequisite.

Increasing the proportion of water in the hydrolysate mixture during or after the hydrolysis reaction enables the equilibrium to be shifted in the direction of a higher proportion of free alcohol (WO 2013/174689). However, since this excess of water has to be, as mentioned above, removed again in an energy-consuming manner during drying, it impairs the economics of the overall process.

Proportions of alcohol also stabilize the solutions of the siliconate salts, so that precipitates caused by shifting of the equilibrium (formation of organosilicic acids) do not occur or occur only after storage for several years. This has an advantageous effect on the logistics, in particular of industrial quantities, when, for example, the hydrolysate is prepared in one place and drying is carried out at a different place.

### SUMMARY OF THE INVENTION

It was an object of the invention to discover a process which can easily be implemented industrially and makes it possible to produce siliconate powders having a significantly reduced alcohol content from alcoholic-aqueous hydrolysate precursors thereof while at the same time reducing the drying time and which thus overcomes the disadvantages of the abovementioned prior art.

The invention provides a process for producing powder (P) composed of salts of silanols, of hydrolysis/condensation products thereof or of silanols together with hydrolysis/condensation products thereof and cations selected from among alkali metal cations, where the molar ratio of cation to silicon is from 0.1 to 3, wherein organoalkoxysilanes, hydrolysis/condensation products thereof or organoalkoxysilanes together with hydrolysis/condensation products thereof, where the alkoxy group is selected from among the methoxy, ethoxy, 1-propoxy and 2-propoxy groups, are reacted in a first step with a basic alkali metal salt and optionally water to give a hydrolysate having an alcohol content of from 2 to 38 percent by weight, a powder having an alcohol content of from 0.5 to 5 percent by weight is produced from the hydrolysate produced in the first step by drying in a second step and the alcohol content is reduced by means of an after-treatment of the powder in a third step, where the powder (P) is obtained with an alcohol content of not more than 1 percent by weight.

### DETAILED DESCRIPTION OF THE PREFERRED EMBODIMENTS

It has surprisingly been found that a very rapid reduction in the alcohol content is possible by means of a simple after-treatment of the free-flowing, alcohol-containing siliconate powder produced in the second step.

The process differs from the prior art in that it involves a stepped drying process. Here, aqueous-alcoholic solutions or dispersions of siliconates, the production of which is described, for example, in WO 12022544 and DE 4336600, are obtained by the reactions of alkoxysilanes with basic alkali metal salts carried out in step 1. In the second step, the solutions or dispersions of siliconates are converted into a free-flowing powder by drying.

In the third step, the powder produced in the second step is subjected to an after-treatment to reduce the alcohol content. The after-treatment is preferably effected by means of
passing a vapor or gas stream through a powder bed (fluidized-bed process)
applying reduced pressure
heating

or combinations of these three methods. The individual steps can be carried out in direct succession in a single apparatus or be carried out in separate sections separated in time in the same apparatus or in each case in an apparatus suitable for the individual step. The steps 1, 2 and 3 are preferably carried out in different apparatuses.

The advantage of the process of the invention is the conversion of the alcohol-containing hydrolysate into a dry, low-alcohol or even alcohol-free organosilanol salt or siliconate powder (P) which is, compared to the prior art, significantly quicker and thus more gentle and cheaper. Salts of organosilanols are referred to as siliconates.

The process of the invention is preferably used to produce salts of organosilanols, where, in the first step, organoalkoxysilanes of the general formula 1

(R¹)ₐSi (OR⁴)_{b}(—Si(R²)_{3-c}(OR⁴)_{c})_{d} (1)

or hydrolysis/condensation products thereof or the organosilanes of the general formula 1 together with hydrolysis/condensation products thereof are used as starting materials,

where

R¹, R² are each a monovalent Si—C-bonded hydrocarbon radical which has from 1 to 30 carbon atoms and is unsubstituted or substituted by halogen atoms, amino groups, C₁₋₆-alkyl or C₁₋₆-alkoxy or silyl groups and in which one or more nonadjacent —CH₂— units can be replaced by —O—, —S— or —NR³— groups and one or more nonadjacent ═CH— units can be replaced by —N═ groups,

R³ is hydrogen or a monovalent hydrocarbon radical which has from 1 to 8 carbon atoms and is unsubstituted or substituted by halogen atoms or NH₂ groups,

R⁴ is a methyl, ethyl, 1-propyl or 2-propyl group,

a is 1, 2 or 3 and

b, c, d are each 0, 1, 2 or 3,

with the proviso that b+c≧1 and a+b+d=4.

It is also possible to use mixtures of these organoalkoxysilanes of the general formula 1 or mixed oligomers of compounds of the general formula 1, or mixtures of these mixed oligomeric siloxanes with monomeric organoalkoxysilanes of the general formula 1. Any silanol groups formed by hydrolysis which are present in the compounds of the general formula 1 or the oligomers thereof do not interfere.

R¹, R² can be linear, branched, cyclic, aromatic, saturated or unsaturated. Examples of amino groups in R¹, R² are —NR⁵R⁶ radicals, where R⁵ and R⁶ can each be hydrogen or a C₁-C₈-alkyl, cycloalkyl, aryl, arylalkyl or alkylaryl radical, each of which can be substituted by —OR⁷, where R⁷ can be C₁-C₈-alkyl, aryl, arylalkyl, alkylaryl. If R⁵, R⁶ are alkyl radicals, nonadjacent CH₂— units therein can be replaced by —O—, —S— or —NR³— groups. R⁵ and R⁶ can also be a ring. R⁵ is preferably hydrogen or an alkyl radical having from 1 to 6 carbon atoms.

R¹, R² in the general formula 1 are each preferably a monovalent hydrocarbon radical which has from 1 to 18 carbon atoms and is unsubstituted or substituted by halogen atoms, amino groups, alkoxy groups or silyl groups. Particular preference is given to unsubstituted alkyl radicals, cycloalkyl radicals, alkylaryl radicals, arylalkyl radicals and phenyl radicals. The hydrocarbon radicals R¹, R² preferably have from 1 to 6 carbon atoms. Particular preference is given to the methyl-, ethyl, propyl, 3,3,3-trifluoropropyl, 3-aminopropyl, 3-(2-aminoethyl)aminopropyl, vinyl, n-hexyl and phenyl radicals, most preferably the methyl radicals.

Further examples of radicals R¹, R² are:

n-propyl, 2-propyl, 3-chloropropyl, 2-(trimethyl-silyl)ethyl, 2-(trimethoxysilyl)ethyl, 2-(triethoxy-silyl)ethyl, 2-(dimethoxymethylsilyl)ethyl, 2-(diethoxymethylsilyl)ethyl, n-butyl, 2-butyl, 2-methylpropyl, t-butyl, n-pentyl, cyclopentyl, n-hexyl, cyclohexyl, n-heptyl, n-octyl, 2-ethylhexyl, n-nonyl, n-decyl, n-undecyl, 10-undecenyl, n-dodecyl, isotridecyl, n-tetradecyl, n-hexadecyl, vinyl, allyl, benzyl, p-chlorophenyl, o-(phenyl)phenyl, m-(phenyl)phenyl, p-(phenyl)phenyl, 1-naphthyl, 2-naphthyl, 2-phenylethyl, 1-phenylethyl, 3-phenylpropyl, N-morpholinomethyl, N-pyrrolidino-methyl, 3-(N-cyclohexyl)aminopropyl, 1-N-imidazolidino-propyl radicals.

Further examples of R¹, R² are —(CH₂O)ₙ—R⁸, —(CH₂CH₂O)ₘ—R⁹, and —(CH₂CH₂NH)ₒH, —(CH₂CH (CH₃)O)ₚ—R¹⁰ radicals, where n, m, o and p are from 1 to 10, in particular 1, 2, 3, and R⁸, R⁹ and R¹⁰ are as defined for R⁵, R⁶.

R³ is preferably hydrogen or an alkyl radical which has from 1 to 6 carbon atoms and is unsubstituted or substituted by halogen atoms. Examples of R³ have been given above for R¹.

d is preferably 0. Preference is given to d being 1, 2 or 3 in not more than 20 mol %, in particular not more than 5 mol %, of the compounds of the general formula 1.

Examples of compounds of the general formula 1 in which a=1 are:

MeSi(OMe)₃, MeSi(OEt)₃, MeSi(OMe)₂(OEt), MeSi(OMe) (OEt)₂, MeSi (OCH₂CH₂OCH₃)₃, H₃C—CH₂—CH₂—Si (OMe)₃, (H₃C)₂CH—Si (OMe)₃, CH₃CH₂CH₂CH₂—Si (OMe)₃, (H₃C)₂CHCH₂—Si (OMe)₃, tBu-Si (OMe)₃, PhSi (OMe)₃, PhSi (OEt)₃, F₃C—CH₂—CH₂—Si (OMe)₃, H₂C═CH—Si (OMe)₃, H₂C═CH—Si (OEt)₃, H₂C═CH—CH₂—Si (OMe)₃, Cl—CH₂CH₂CH₂—Si (OMe)₃, n-Hex-Si (OMe)₃, cy-Hex-Si (OEt)₃, cy-Hex-CH₂—CH₂—Si (OMe)₃, H₂C═CH—(CH₂)₉—Si (OMe)₃, CH₃CH₂CH₂CH₂CH (CH₂CH₃)—CH₂—Si (OMe)₃, hexadecyl-Si (OMe)₃, Cl—CH₂—Si (OMe)₃, H₂N—(CH₂)₃—Si (OEt)₃, cyhex-NH—(CH₂)₃—Si (OMe)₃, H₂N—(CH₂)₂—NH—(CH₂)₃—Si (OMe)₃, O(CH₂CH₂)₂N—CH₂—Si (OEt)₃, PhNH—CH₂—Si(OMe)₃, hexadecyl-SiH₃, (MeO)₃Si—CH₂CH₂—Si(OMe)₃, (EtO)₃Si—CH₂CH₂—Si (OEt)₃, (MeO)₃SiSi (OMe)₂Me, MeSi (OEt)₂Si (OEt)₃.

Preference is given to MeSi(OMe)₃, MeSi(OEt)₃, (H₃C)₂CHCH₂—Si (OMe)₃ and PhSi(OMe)₃, with methyltrimethoxysilane and the hydrolysis/condensation product thereof being particularly preferred.

Examples of compounds of the general formula 1 in which a=2 are:

Me₂Si(OMe)₂, Me₂Si(OEt)₂, Me₂Si (OCH (CH₃)₂)₂, MeSi (OMe)₂CH₂CH₂CH₃, Et₂Si (OMe)₂, Me₂Si (OCH₂CH₂OCH₃)₂, MeSi(OMe)₂Et, (H₃C)₂CH—Si(OMe)₂Me, Ph-Si(OMe)₂Me, t-Bu-Si(OMe)₂Me, Ph₂Si(OMe)₂, PhMeSi(OEt)₂, MeEtSi(OMe)₂, F₃C—CH₂—CH₂—Si (OMe)₂Me, H₂C═CH—Si (OMe)₂Me, H₂C═CH—CH₂—Si (OMe)₂Me, Cl—CH₂CH₂CH₂—Si (OMe)₂Me, cy-Hex-Si (OMe)₂Me, n-Hex-Si (OMe)₂Me, cy-Hex-CH₂-CH₂—Si (OMe)₂Me, H₂C═CH—(CH₂)₉—Si (OMe)₂Me, Cl—CH₂—SiMe (OMe)₂, H₂N—(CH₂)₃—SiMe (OEt)₂, cyhex-NH—(CH₂)₃—SiMe (OMe)₂, H₂N—(CH₂)₂—NH—(CH—₂)₃—SiMe(OMe)₂, O(CH₂CH₂)₂N—CH₂—SiMe (OMe)₂, PhNH—CH₂—SiMe (OMe)₂, (MeO)₂MeSi—CH₂CH₂—SiMe (OMe)₂, (EtO)₂MeSi—CH₂CH₂—SiMe (OEt)₂, (MeO)₂MeSiSi(OMe)₂Me, MeSi(OEt)₂SiMe(OEt)₂, Me₂Si(OMe)Si(OMe)₃, Me₂Si (OMe) Si (OMe)Me₂, Me₂Si (OMe) SiMe₃, Me₂Si (OMe) SiMe (OMe)₂.

Preference is given to Me₂Si(OMe)₂, Me₂Si(OEt)₂, MeSi(OMe)₂CH₂CH₂CH₃ and Ph-Si(OMe)₂Me, with Me₂Si(OMe)₂ and MeSi(OMe)₂CH₂CH₂CH₃ being particularly preferred.

Me is the methyl radical, Et is the ethyl radical, Ph is the phenyl radical, t-Bu is the 2,2-dimethylpropyl radical, cy-Hex is the cyclohexyl radical, n-Hex is the n-hexyl radical, hexadecyl is the n-hexadecyl radical.

Preference is given to a being 1 or 2.

In particular, at least 50%, preferably at least 60%, more preferably at least 70%, and not more than 80%, preferably not more than 90%, and more preferably not more than 100%, of all radicals R¹ in the compounds of the general formula 1 or the hydrolysis/condensation products thereof are methyl radicals, ethyl radicals or propyl radicals.

The basic alkali metal salts preferably have a pk_{B} of not more than 12, more preferably not more than 10, and in particular not more than 5. Compounds which form solvated hydroxide ions in water and contain alkali metal ions as cations are used as basic alkali metal salts. Preference is given to using alkali metal hydroxides such as lithium hydroxide, sodium hydroxide, potassium hydroxide and cesium hydroxide, most preferably sodium hydroxide and potassium hydroxide, as alkali metal salts. Further examples of alkali metal salts are alkali metal carbonates such as sodium carbonate and potassium carbonate and also alkaline metal hydrogencarbonates such as sodium hydrogencarbonate, alkali metal formates such as potassium formate, alkali metal silicates (water glass) such as sodium orthosilicate, disodium metasilicate, disodium disilicate, disodium trisilicate or potassium silicate. Furthermore, it is also possible to use alkali metal oxides, alkali metal amides or alkali metal alkoxides, preferably those which liberate the same alcohol as the compounds of the general formula 1 used.

It is also possible to use mixtures of various salts of optionally different alkali metals, for example mixtures of sodium hydroxide and potassium hydroxide. Typical secondary constituents in technical grades of the basic salts (i.e. purities of from 80 to 99% by weight), for example water or other salts present, e.g. proportions of sodium in potassium salts or carbonates in hydroxides, generally do not interfere and can be tolerated. A further preferred variant is the use of alkali metal organosiliconates, in particular aqueous or aqueous-alcoholic preparations of alkali metal organosiliconates, optionally in admixture with other alkali metal salts, preferably alkali metal hydroxides. This may be advantageous when the siliconate or the aqueous or aqueous-alcoholic siliconate preparation (solution, suspension, emulsion) is, for example, produced in large quantities as a commercial product, so that only one further reaction step is required in order to produce the powders (P).

For example, a compound of the general formula 1 can be reacted with an aqueous solution of a potassium methylsiliconate (e.g. WACKER SILRES® BS 16). Preferred compounds of the general formula 1 which can be reacted with commercially available alkali metal methylsiliconates include Me—Si(OMe)₃, Et-Si(OMe)₃, Ph-Si(OMe)₃, propyl-Si(OMe)₃, butyl-Si(OMe)₃, hexyl-Si(OMe)₃, octyl-Si(OMe)₃ and their possible constitutional isomers or stereoisomers, where Me is the methyl radical, Et is the ethyl radical, Ph is the phenyl radical, propyl is a 1-propyl or 2-propyl radical, butyl is an n-butyl radical or a branched butyl radical, octyl is an n-octyl radical or an octyl radical which is branched or has a cyclic structure and hexyl is an n-hexyl radical or a hexyl radical which is branched or has a cyclic structure, each of which can be bound to Si at any carbon atom. This route is particularly advantageous when siliconate powders containing other radicals R¹ and R² in addition to methyl radicals are to be produced.

Steps 1 and 2 in the process of the invention can be combined by reacting solid alkali metal organosiliconates, preferably pulverulent alkali metal organosiliconates, with compounds of the general formula 1 in the absence or presence of water. This variant is particularly advantageous in the case of commercially available solid alkali metal organosiliconates such as SILRES® BS powder S (a pulverulent potassium methylsiliconate from WACKER CHEMIE AG). This route is particularly advantageous when siliconate powders containing other radicals R¹ and R² in addition to methyl radicals are to be produced. Here, the methylsiliconate powder can be reacted with compounds of the general formula 1 in which R¹ and R² or R¹ or R² are not methyl radicals.

The amount of alkali metal salt is preferably selected so that the resulting molar ratio of cation to silicon is at least 0.2, preferably at least 0.4, more preferably at least 0.5, and in particular at least 0.6, and not more than 3.0, preferably not more than 1.0, more preferably not more than 0.8, and in particular not more than 0.7.

The reaction of the compounds of the general formula 1 with basic salts is usually exothermic and is therefore preferably carried out with temperature-controlled addition of one component to the other or parallel introduction, optionally into a previously produced reaction mixture, preferably at temperatures of at least 0° C., more preferably at least 10° C., and preferably at least 20° C., preferably up to the boiling point of the liberated alcohol, and preferably under an inert gas (nitrogen, argon, lean air) at the pressure of the surrounding atmosphere. However, the reaction can also be carried out at higher or lower pressure, with pressures above 10,000 hPa offering no advantages. In addition, solvents can also be present in the reaction so as to ensure better solubility of the components, for example alcohols such as methanol, ethanol or isopropanol, ketones such as acetone and methyl isobutyl ketone (MIBK), sulfoxides such as dimethyl sulfoxide (DMSO), amides such as N,N-dimethylformamide (DMF) and N-methylpyrrolidone (NMP), ethers such as methyl t-butyl ether (MTBE), diethyl ether and dibutyl ether or polyethers such as polyethylene glycols having molar masses in the range from 100 to 300 g/mol, and thus contribute to acceleration of the reaction. The proportion of added solvent is preferably not more than 40% by weight, more preferably not more than 20% by weight, and in particular no additional solvents are present.

The reaction can be carried out in a batch process, e.g. in a stirred vessel, or continuously, e.g. in a loop reactor or tube reactor or a reactive distillation.

The concentration of alcohol(s) in the hydrolysates from step 1 is preferably at least 3% by weight and not more than 35% by weight, more preferably at least 5% by weight and not more than 30% by weight, and in particular not more than 25% by weight. The alcohol concentration is preferably determined by calculation from the amount of alcohol theoretically liberated from the compound of the general formula 1.

In step 2, a dry, free-flowing powder is produced from the hydrolysate from step 1. This is preferably brought about by drying with direct wall contact with a heated surface (e.g. in a paddle dryer or thin film evaporator), drying in a fluidized-bed dryer or spray dryer. Depending on the alcohol content of the mixture, drying is carried out under inert gas (e.g. nitrogen, argon, helium, lean air containing a maximum of 2% of oxygen). Drying in the paddle dryer or fluidized-bed dryer can be carried out by the methods described in WO 13075969 and WO 13041385. Spray drying can be carried out in any apparatuses which are suitable for spray drying liquids and are commonly known, for example those having at least a two-fluid nozzle, a cemented hard material nozzle or hollow cone nozzle or a torsional atomizer nozzle or a rotary atomizer disk, in a heated stream of dry gas. The inlet temperature of the dry gas stream, which is preferably air, lean air or nitrogen, in the spray drying apparatus is preferably from 110° C. to 350° C., more preferably at least 110° C., and not more than 250° C., in particular at least 110° C. and not more than 180° C. The outlet temperature of the gas stream formed during drying is preferably from 40 to 120° C., in particular from 60 to 110° C. The spraying pressure is preferably at least 500 hPa, more preferably at least 800 hPa, and not more than 500,000 hPa, in particular not more than 10,000 hPa. The rotational speed of the atomizer nozzle is usually in the range from 4000 to 50,000 rpm. Step 2 is preferably carried out by spray drying in a spray dryer or drying in a fluidized-bed dryer, more preferably by spray drying in a spray dryer. The powders obtained in step 2 are preferably free-flowing and preferably have an alcohol content of preferably not more than 5 percent by weight, more preferably not more than 4 percent by weight, and in particular not more than 3 percent by weight. The alcohol content encompasses both the chemically bound alcohol and the adsorbed alcohol. It is preferably determined on a solution of the powder by NMR spectroscopy. Here, the addition of base, preferably alkali metal hydroxide, can be useful in order to ensure solubility. Reference quantities employed are the proportions by weight of all siloxy units (R¹)ₐSi (O_{1/2})_{b}[(—Si (R²)_{3-c} (O_{1/2})_{c}]_{d}, which can be derived from the formula 1, for example (R¹)ₐSi (O_{1/2})_{b}[(—Si (R²)_{3-c}(O_{1/2})_{c}]_{d} or (R¹)ₐSi (O_{1/2})_{b}, and the proportions by weight of the alkoxy units R⁴O_{1/2} and the proportions by weight of the free alcohol R⁴OH. The alcohol content is preferably determined on the basis of the mol percent of the fragments mentioned, which can be derived from the ¹H-NMR spectrum, and their molar masses; here, the masses/proportions by weight of the fragments R⁴O_{1/2} present and of the free alcohol R⁴OH are added up and their sum is reported as alcohol content.

Apart from solutions, suspensions in which the siliconate salt is present in undissolved form can also be used in the second step. It is also possible to dry mixtures of alcoholic-aqueous mixtures of various siliconate salts by the process of the invention, with one or more alcohols being able to be present.

In step 3, adhering and bound residual alcohol and the water present or formed in the drying process, possibly by chemical condensation processes, is preferably removed. Drying is preferably carried out here to a residual moisture content in a measurement using the HR73 Halogen Moisture Analyzer from Mettler Toledo or a comparable measuring instrument on the powder (P) at 160° C. of not more than 3% by weight, particularly preferably not more than 1% by weight, in particular not more than 0.5% by weight, based on the initial weight.

Both steps are preferably carried out with exclusion of oxygen, in particular under an inert gas atmosphere, e.g. an atmosphere composed of nitrogen, argon, helium. The alcohol content of the powder (P) produced according to the invention is preferably not more than 1% by weight, more preferably not more than 0.8% by weight, yet more preferably not more than 0.1% by weight, and in particular not more than 0.05% by weight, preferably according to the above definition.

The drying or wall temperature, i.e. the highest temperature with which the mixture to be dried comes into contact, is preferably selected so that thermal decomposition of the reaction mixture within the entire drying time is largely avoided. For this purpose, the time to the maximum rate of the thermal decomposition under adiabatic conditions (=Time to Maximum Rate=TMR_{ad}) is usually determined on the hydrolysate mixture at various temperatures by means of DSC measurements and the maximum temperature at which, optionally with maintenance of a safety margin, no uncontrolled exothermic decomposition has to be feared within the time of thermal stressing during drying is selected. The drying or wall temperature is preferably selected so that the TMR_{ad} is at least 200%, more preferably at least 150%, and most preferably at least 100%, of the drying time. This gives the maximum achievable degree of drying in step 2 and step 3: at relatively high temperatures, a lower residual alcohol content is obtained than at lower temperatures. To achieve a high space-time yield, the temperature should therefore be as high as possible. When drying is carried out in a paddle dryer, thin film evaporator or fluidized-bed dryer, the drying or wall temperature in step 2 is preferably at least 70° C., more preferably at least 90° C., and in particular at least 100° C., and preferably not more than 250° C., more preferably not more than 200° C., and in particular not more than 150° C., as long as no unacceptable thermal decomposition occurs at these temperatures and the selected contact times. In so far as step 2 or step 3 can occur under reduced pressure, a very low pressure is advantageous because it reduces the duration of drying at the same temperature or makes possible a reduction in temperature at the same residence time. When step 2 or step 3 is carried out in a paddle dryer or stirred vessel, the maximum temperature which is permissible according to the thermal decomposition data is preferably selected and drying is carried out under reduced pressure (preferably at pressures of <10 hPa). When step 3 is carried out by the fluidized-bed process, a heated gas stream (air or inert gas such as nitrogen or argon) which is dry or humidified with water vapor is passed, preferably at atmospheric pressure or slightly superatmospheric pressure, through a powder bed in such a way that fluidization occurs. The process parameters such as temperature, gas flow rate and throughput can easily be adapted and optimized for the respective apparatus by a person skilled in the art. Since the residence times in the fluidized-bed process are significantly shorter than in a stirred vessel, it is possible to select higher drying temperatures than in the case of direct wall contact. The gas or vapor temperature in the fluidized-bed process in step 3 is preferably at least 100° C. and not more than 300° C., more preferably at least 150° C. and not more than 250° C.

The process of the invention allows incomplete but significantly shorter drying to give an alcohol-containing powder in step 2, which is then after-dried in step 3. Since the free-flowing powder isolated in step 2 already takes up a significantly smaller volume than the liquid mixture from step 1, the dimensions of the apparatus for step 3 can be made smaller than in step 2, which makes better heat transfer during after-drying possible. This is a considerable advantage compared to the two-stage process described in WO 13041385, in which the viscous phase formed from the hydrolysate in the first step has to be after-dried under reduced pressure, advantageously in the same apparatus (which has dimensions sufficient for the first step). The drying in the powder bed described in WO 13075969 also takes significantly longer, without after-drying, if low residual alcohol contents are to be obtained. Here too, more rapid introduction into the powder bed leads to an alcohol-containing powder which leads, in a second step in a smaller apparatus having significantly better heat transfer, to a substantially alcohol-free end product powder (P). Drying time can be saved by this combination. The individual successive steps of the process of the invention can be carried out continuously or batchwise; step 1 and step 2 or step 2 and step 3 or all three steps can be coupled to one another in process engineering terms. The steps 2 and 3 are preferably carried out in direct succession. Particular preference is given to carrying out step 2 in a spray dryer and step 3 in a fluidized bed in a fluidized-bed dryer connected directly to the spray dryer and continuous drying thus being made possible.

Support materials to improve and accelerate particle formation, e.g. minerals, alkali metal silicates or alkaline earth metal silicates, ceramic powders, gypsum, magnesium carbonate, calcium carbonate, aluminosilicates, clays, organosiliconates can be added during steps 2 or 3, or additives such as antifoams, flow aids, anticaking agents and humectants can be added before, during or after the process of the invention.

If desired, the solids obtained by the process of the invention can, for example, be comminuted by milling processes or compacted to form coarser particles or shaped bodies, e.g. granules, briquettes, pellets, and then sifted, sieved or classified.

The powders (P) and forms or solutions which can be produced therefrom can be used as auxiliaries for reducing the water absorption of building materials, known as hydrophobicizing additives. Here, they are usually added only on-site in the dry mix process to a dry mortar which is then, usually on the building site, admixed with the make-up water, with these additives then being able to display their hydrophobicizing action (composition hydrophobicization) in the resulting aqueous slurry. The objective here is for the finished mortar and also the completely worked and dried mortar to have a lower water absorption than the unhydrophobicized comparative mortar. Dry mortars of the abovementioned type can be, for example, plasters and renders, screeds, self-leveling compositions, knifing fillers or various adhesives.

Particularly in the demanding field of decorative elements and fine knifing fillers, which have to equalize very fine unevennesses, have to fill very fine cracks and have to be spread out into very thin layer thicknesses (known as finishing), a maximum particle size of from 150 to not more than 180 microns and also a homogeneous and monomodal particle size distribution in a very sharply defined particle size range are required. Conventionally dried siliconate powders which are obtained in a single-stage drying process, e.g. directly from a paddle dryer, contain agglomerates having a size of from 500 microns through to 1-2 cm. Subsequent milling, sieving and sifting is therefore indispensible for conventionally dried siliconate powders. The advantage of the powders (P) when the 2nd step is carried out in a spray-drying plant is a monomodal and uniform particle size distribution, the width of which can be set from the beginning by means of selected spraying and nozzle parameters and thus via the droplet size distribution of the material being sprayed and which can in the illustrated case of fine knifing fillers be preselected in the range from 0 to 150 microns or up to a maximum of 180 microns, without subsequent milling, sieving and sifting being required.

In the case of fine knifing fillers, it is possible for undesirable coarse grains having a particle size of greater than 180 microns to lead, during knifing and working of the composition, to defects, traces and scratches which reduce the product quality and which can be evened out only with difficulty, with evening out taking time. In the case of corresponding fine knifing fillers containing the powders (P) as hydrophobicizing additives, these defects do not occur, which represents a clear advantage.

The invention thus also provides powder (P) which can be produced by the above process in which the hydrolysate produced in the first step is spray-dried in the second step, the building material mixtures which are equipped therewith, which include, for example, gypsum- or cement-based dry mortars, plasters and renders, knifing fillers, fine knifing fillers, self-leveling compositions, in-situ concrete and spray concrete, and also components and shaped bodies produced therefrom.

The meanings of all above symbols in the above formulae are in each case independent of one another. In all formulae, the silicon atom is tetravalent.

In the following examples and comparative examples, all amounts and percentages indicated are, unless indicated otherwise in the particular case, by weight and all reactions are carried out at a pressure of 1000 hPa (abs.).

The solids content is in each case determined by means of the HR73 Halogen Moisture Analyzer from Mettler Toledo at 160° C. The methoxy/methanol content was determined by means of ¹H-NMR spectroscopy as described above.

### EXAMPLE 1

### Three-stage Process According to the Invention for Drying a Potassium Methylsiliconate (K:Si=0.65:1)

In step 1, 100 g of WACKER SILRES® BS 16 (commercial product of WACKER CHEMIE AG, aqueous solution of potassium methylsiliconate having a solids content of 54% by weight and a potassium content of 0.41 mol/100 g) are placed in a 500 ml five-necked glass flask which has been made inert by means of nitrogen and is equipped with blade stirrer, thermometer and distillation bridge at 22° C. While stirring vigorously, 31.2 g (0.225 mol) of methyltrimethoxysilane (commercially available from WACKER CHEMIE AG, 98% purity) are introduced over a period of 20 minutes. The temperature of the reaction mixture rises to 33° C. A clear solution having a solids content of 53% by weight and a calculated methanol content of 16.5% by weight is obtained. This solution is, in step 2, fed over a period of 30 minutes on to a fluidized bed which is composed of 56 g of SILRES® BS powder S (commercial product of WACKER CHEMIE AG, potassium methylsiliconate having a molar ratio of K:Si of 0.65) and is fluidized by means of nitrogen having a temperature of 150° C. 126.8 g of a white, free-flowing powder having a solids content of 98% by weight and a methanol/methoxy content determined by NMR spectroscopy of 1.3% by weight is isolated. In step 3, the powder from step 2 is treated in a fluidized-bed reactor (reversible frit) with a stream of 10 L/min of nitrogen maintained at 160° C. and having a gauge pressure of 10 hPa. After 30 minutes, the methanol/methoxy content is 0.9% by weight, and after a further 20 minutes it is 0.63% by weight.

### EXAMPLE 2

### Three-stage Process According to the Invention for Drying a Mixed Potassium Methyl/Hexylsiliconate (K:Si=0.57:1)

In step 1, 110 g (about 1 mol of Si) of WACKER SILRES® BS powder S (commercial product of WACKER CHEMIE AG, potassium methylsiliconate having a molar ratio of K:Si of 0.65) are placed in a 500 ml five-necked glass flask which has been made inert by means of nitrogen and is equipped with blade stirrer, thermometer and distillation bridge at 100° C. and 2 hPa. While stirring vigorously, 28.7 g (0.135 mol) of n-hexyltrimethoxy-silane (prepared from 1-hexene and trichlorosilane and subsequent reaction with methanol, 97% purity) are introduced over a period of 15 minutes. The mixture is stirred for a further 10 minutes. Methanol formed is condensed and collected in a receiver. 125.3 g of a white coarse-grained powder having a solids content of 95.7% by weight is obtained. The proportion of methoxy/methanol is determined by NMR spectroscopy: it is 3.8% by weight based on the sum of MeSiO_{3/2}, MeO_{1/2}, hexylSiO_{3/2} and MeOH components. The methoxy/methanol content is reduced to 0.01% by weight by after-drying for 40 minutes in a stirred glass flask at a wall temperature of 100° C. and 1 hPa.

### EXAMPLE 3

### Three-stage Process According to the Invention for Drying a Potassium Methylsiliconate (K:Si=0.65:1)

In step 1, a hydrolysate H1 is produced in a manner analogous to example 1 in DE 4336600 from one molar equivalent of methyltrimethoxysilane (prepared from 1 molar equivalent of methyltrichlorosilane and 3 molar equivalents of methanol), 0.65 molar equivalent of potassium hydroxide and 4.5 molar equivalents of water (in the form of a 31% strength potassium hydroxide solution).

Solids content=43% by weight (according to ¹H-NMR, contains 38% by weight of methanol and 18.7% by weight of water). The viscosity is 22 mm²/s.

In step 2, 500 g of solution from step 1 are fed at 3 hPa over a period of 40 minutes on to a stirred bed of 500 g of WACKER SILRES® BS powder S (commercially available from WACKER CHEMIE AG, potassium methylsiliconate having a molar ratio of K:Si of 0.65) maintained at 130° C. 703 g of a white, dry free-flowing powder having a solids content of 99.8% by weight are isolated. The proportion of methoxy/methanol is determined by NMR spectroscopy: it is 0.13% by weight based on the sum of MeSiO_{3/2}, MeO_{1/2} and MeOH components. The methanol content is reduced to 0.01% by weight by after-drying for 35 minutes in a stirred glass flask at a wall temperature of 100° C. and 1 hPa. The total drying time is accordingly about 80 minutes. Despite a somewhat higher water content compared to the prior art (WO 13041385, example 1), the time for producing a comparable methylsiliconate powder quality is thus reduced from 2 hours to about 1.5 hours.

### EXAMPLE 4

### Three-stage Process According to the Invention for Drying a Potassium Methylsiliconate (K:Si=0.65:1)

In step 1, 100 g of WACKER SILRES® BS 16 (commercial product of WACKER CHEMIE AG, aqueous solution of potassium methylsiliconate having a solids content of 54% by weight and a potassium content of 0.41 mol/100 g) are placed in a 500 ml five-necked glass flask which has been made inert by means of nitrogen and is equipped with blade stirrer, thermometer and distillation bridge at 22° C. While stirring vigorously, 31.2 g (0.225 mol) of methyltrimethoxysilane (commercially available from WACKER CHEMIE AG, 98% purity) are introduced over a period of 20 minutes. The temperature of the reaction mixture rises to 33° C. A clear solution having a solids content of 53% by weight and a methanol content of 16.5% by weight is obtained. In step 2, 130 g of the solution from step 1 are fed at 3 hPa over a period of 15 minutes on to a stirred bed of 150 g of WACKER ® BS powder S (commercially available from WACKER CHEMIE AG, potassium methylsiliconate having a molar ratio of K:Si of 0.65) maintained at 150° C. 214 g of a white, dry free-flowing powder having a solids content of 98.4% by weight are isolated. The proportion of methoxy/methanol is determined by NMR spectroscopy: it is 1.1% by weight based on the sum of MeSiO_{3/2}, MeO_{1/2} and MeOH components.

In step 3, the powder from step 2 is treated in a fluidized-bed reactor (reversible frit) with a stream of 7 l/min of nitrogen maintained at 180° C. and having a gauge pressure of 8 hPa. After 30 minutes, the methanol/methoxy content is 0.08% by weight.

1.-14. (canceled)

15. A process for producing a powder comprising salts of silanols, of hydrolysis/condensation products thereof, or of silanols together with hydrolysis/condensation products thereof, and alkali metal cations, where the molar ratio of cation to silicon is from 0.1 to 3, comprising:
in a first step, reacting organoalkoxysilanes, hydrolysis/condensation products thereof or organoalkoxysilanes together with hydrolysis/condensation products thereof, where the alkoxy group is selected from among the methoxy, ethoxy, 1-propoxy and 2-propoxy groups with a basic alkali metal salt and optionally water to give a hydrolysate having an alcohol content of from 2 to 38 percent by weight,
in a second step, drying the hydrolysate produced in the first step to produce a powder having an alcohol content of from 0.5 to 5 percent by weight, and
in a third step, reducing the alcohol content by means of an after-treatment of the powder obtained in the second step, obtaining a powder with an alcohol content of not more than 1 percent by weight.

16. The process of claim 15, wherein salts of organosilanols are produced, where, in the first step, organoalkoxysilanes of the formula 1
(R¹)ₐSi(OR⁴)_{b}(—Si(R²)_{3-c}(OR⁴)_{c})_{d} (1)
or hydrolysis/condensation products thereof or the organosilanes of the formula 1 together with hydrolysis/condensation products thereof are used as starting materials,
where
R¹, R² are each individually a monovalent Si—C-bonded hydrocarbon radical which has from 1 to 30 carbon atoms and is unsubstituted or is substituted by halogen atoms, amino groups,
C₁₋₆-alkyl or C₁₋₆-alkoxy or silyl groups and in which one or more nonadjacent —CH₂— units are optionally replaced by—O—, —S— or —NR³— groups and one or more nonadjacent ═CH-units are optionally replaced by —N═ groups,
R³ is hydrogen or a monovalent hydrocarbon radical which has from 1 to 8 carbon atoms and is unsubstituted or substituted by halogen atoms or NH₂ groups,
R⁴ is a methyl, ethyl, 1-propyl or 2-propyl group,
a is 1, 2 or 3 and
b, c, d are each 0, 1, 2 or 3,
with the proviso that b+c≧1 and a+b+d=4.

17. The process of claim 16, wherein R¹, R² are each an alkyl radical having from 1 to 6 carbon atoms.

18. The process of claim 15, wherein the basic alkali metal salts comprise alkali metal hydroxides, alkali metal carbonates, alkali metal organosiliconates, or mixtures thereof.

19. The process of claim 15, wherein the alcohol content of the hydrolysate from the first step is from 3 to 30% by weight.

20. The process of claim 15, wherein drying in the second step is carried out in a fluidized bed, paddle dryer, thin film evaporator or spray dryer.

21. The process of claim 15, wherein the powder produced in the second step has an alcohol content of not more than 3 percent by weight.

22. The process of claim 15, wherein the alcohol content of the powder is reduced to a value of not more than 0.8 percent by weight in the third step.

23. The process of claim 15, wherein the residual moisture content of the powder in a measurement at 120° C. is reduced to a value of not more than 1.5 percent by weight in the third step.

24. The process of claim 15, wherein drying in the second step is effected by spray drying or fluidized-bed drying.

25. The process of claim 15, wherein drying in the third step is carried out in a paddle dryer, fluidized-bed dryer or stirred vessel.

26. A powder produced by the process of claim 15, wherein the hydrolysate produced in the first step is spray dried in the second step.

27. A building material mixture, comprising a powder of claim 26.

28. A component or shaped body produced from a building material mixture of claim 27.
